(19) United States
(12) Patent Application Publication
(10) Pub. No.: US 2019/0234822 A1
(43) Pub. Date: Aug. 1, 2019

(54) HOT-SWAPPABLE ACCESS/RETRIEVAL PLUG FOR HIGH PRESSURE FLUID SYSTEMS

(71) Applicant: General Electric Company, Schenectady, NY (US)

(72) Inventors: Christian Nomme, Jar (NO); Christopher Grinde, Blommenholm (NO); Per Johan Petersson, Oslo (NO); Bjørn Erik Seeberg, Oslo (NO)

(21) Appl. No.: 16/338,596

(22) PCT Filed: Oct. 6, 2017
(86) PCT No.: PCT/US17/55500

§ 371 Date: Apr. 1, 2019

Related U.S. Application Data
(60) Provisional application No. 62/405,497, filed on Oct. 7, 2016.

(51) Int. Cl. G01L 19/00; G01L 19/06

(52) U.S. Cl. CPC G01L 19/003; G01L 19/0645

(57) ABSTRACT

A system is provided for facilitating the removal/replacement components in a high pressure process fluid system and includes a retrieval plug having a first end portion disposed within a first cavity of a process fluid conduit and a second end disposed within a second cavity of a blind flange, the first cavity exposed to the pressure environment of the process fluid, and a cap disposed between the blind flange and the second end portion of the access plug. The access plug is configured to transfer an indicated pressure from the first end portion to the second end portion and the cap is configured to transfer the indicated pressure to a pressure measurement sensor disposed remotely of the access plug.

### CROSS-REFERENCE TO RELATED APPLICATION

This application is a Non-Provisional patent application and claims the benefit and priority of U.S. Provisional Patent Application No. 62/405,497, filed on Oct. 7, 2016. The entire content and disclosure of such application are hereby incorporated by reference.

### BACKGROUND

Releasing/replacing components of high pressure fluid systems without de-pressurizing or shutting down the system under pressure can be challenging. It will be appreciated that such systems may be costly to shut-down and present safety hazards whenever replacing the components under pressure. With respect to the latter, a pin-hole or fluid-stream under high-pressure, e.g., twenty-thousand (20,000) psi, can quickly become a fluid knife capable of inflicting serious operator injury.

In some instances, systems and methods for pressure measurement, whether being performed on-shore or in sub-sea applications, include devices which include a pressure measuring sensor. Such sensors can require at least two access ports to allow a counteracting pressure to be introduced for installation/calibration and retrieval of the plug/sensor. As mentioned in the preceding paragraph, additional access ports can createan opportunity for a hazardous condition. Commonly-owned U.S. Patent Publication 2014/0298914 describes a retrievable pressure sensor for in-situ measurement of pressure in a process fluid and is hereby incorporated herein by reference in its entirety.

In practice, the use of valves has proven to be difficult in some circumstances inasmuch as, when left in an open position for a prolonged period, the valves can be subject to being fouled by the process fluid. A risk is, therefore, imposed by a potentially faulty valve, i.e., an inoperable valve, when it is finally employed for the replacement of a pressure sensor, i.e., some 10-15 years later. Moreover, when such valves are eventually used, it can be difficult to avoid discharge of the process fluid into the environment. It will be appreciated that such discharge may require costly environmental clean-up of the surrounding water supply or soil.

### SUMMARY OF THE DISCLOSURE

The subject matter disclosed herein relates to a device facilitating the release and replacement of valves in high pressure fluid systems and, more particularly, to an access/retrieval plug configured for in-situ measurement of pressure in a process fluid.

For example, it may be beneficial for a sensor retrieval system to facilitate the removal and replacement of a component, e.g., a pressure sensor, disposed in a high pressure fluid environment which does not render the component inoperable and/or require a suspension in production/process when opening the pipe or conduit to its surrounding environment. The sensor retrieval system may meet safety requirements, which may be strict.

The system comprises a retrieval plug having a first end portion disposed within a first cavity of a process-fluid conduit, and a second end disposed within a second cavity of a blind flange fitting. The first cavity is exposed to the pressure environment of the process fluid and the retrieval plug is configured to transfer an indicated pressure from the first to the second end portion. A cap is disposed between the blind flange and the second end portion of the retrieval plug. Furthermore, the cap is configured to transfer the indicated pressure to a pressure measurement sensor disposed remotely of the retrieval plug.

A method is also provided for protecting an operator from a high pressure waterjet discharge by encapsulating an access/retrieval plug within a cavity of a blind flange. The method comprising the steps of: communicating an indicated pressure of a process fluid through a retrieval plug, and communicating the indicated pressure to a remote sensor. The above embodiments are exemplary only. Other embodiments are within the scope of the disclosed subject matter.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the disclosed subject matter encompasses other embodiments as well. The drawings are not necessarily to scale, emphasis generally being placed upon illustrating the features of certain embodiments of the invention. In the drawings, like numerals are used to indicate like parts throughout the various views.

FIG. 1 is an broken-away, cross-sectional view of a high-pressure well-head including one or more back pressure valves and at least one plug useful for removal of the back-pressure valves;

FIG. 2 is an exploded cross-sectional view of one embodiment of a system facilitating the repair and replacement of components employed in a high pressure fluid environment wherein an access/retrieval plug is disposed between a wall of a process-fluid conduit and a blind flange, and a cap is disposed between the blind flange and the second end portion of the access/retrieval plug;

FIG. 3 is an assembled view of the access/retrieval plug disposed between the blind flange and a wall of the fluid-containing conduit, wherein the blind flange produces a first sealing interface with the wall of the fluid-containing conduit and the cap produces a second sealing interface with the second end portion of the access/retrieval plug;

FIG. 4 depicts an enlarged view of the first end of the access/retrieval plug including a first diaphragm disposed over a pressure transfer tube;

FIG. 5 depicts an enlarged view of the second end of the access/retrieval plug including: (i) a second diaphragm disposed over the second end of the access/retrieval plug, (ii) a third diaphragm disposed over an end of the spring-biased cap, (iii) a flexible tubing disposed between the spring-biased cap and an underside of the blind flange and (iv) a coil spring operative to bias the cap against the access/retrieval plug to produce the second sealing interface;

FIG. 6 depicts an isolated cross-sectional view of the blind flange wherein the remote pressure measurement sensor is disposed externally of the blind flange; and

FIG. 7 depicts an isolated cross-sectional view of the blind flange wherein the remote pressure measure sensor is disposed internally of the blind flange.

### DETAILED DESCRIPTION

The disclosure describes a system and method for use in connection with fluids under pressure which may be contained within a high pressure fluid conduit. Such fluids can create a hazardous condition for operators assigned to repair and replace internal components as may be required during routine maintenance or when a condition calls for maintenance attention. The system produces an interface or connection within a cavity of the fitting which facilitates pressure measurement across the interface while allowing an operator to safely disconnect or decouple the fitting from the fluid conduit. A pair of opposed diaphragms produce the interface wherein the displacement of one diaphragm may be communicated to the other diaphragm so as to allow a remote pressure sensor to measure the fluid pressure.

More specifically, the disclosure describes transferring information, e.g., pressure information, across a plug which provides access to the process fluid in a high pressure system. The system may employ a series of transfer tubes and a modified access plug to transfer information to a remote sensor. The remote sensor may be repaired and replaced without the need to open the high-pressure system to atmosphere and/or to expose an operator to the hazards associated with repair and replacement. Furthermore, the system can employ a redundant series of sealing interfaces, which may improve system safety and prevent contamination/leakage. Finally, the simplified system can minimize the opportunity for flaws in the repair of internal components.

An exemplary embodiment of the disclosure is described in the context of a high-pressure well-head for an oil drilling platform, although the teachings described herein are equally applicable to other systems, including any high pressure fluid system having a requirement for periodic repair and/or replacement of a sensor, valve or other component. Pressure can be communicated across various interfaces such as across diaphragms, through one or more transfer tubes, or across a compliant interface. This is not communicated as an actual pressure value, but rather, as a physical/tangible/measureable displacement indicative of a pressure value. Ultimately, pressure may be detected or measured by a sensor measurement device 80. In some instances, the sensor measurement device 80 may be located remotely or outside of the blind flange 28.

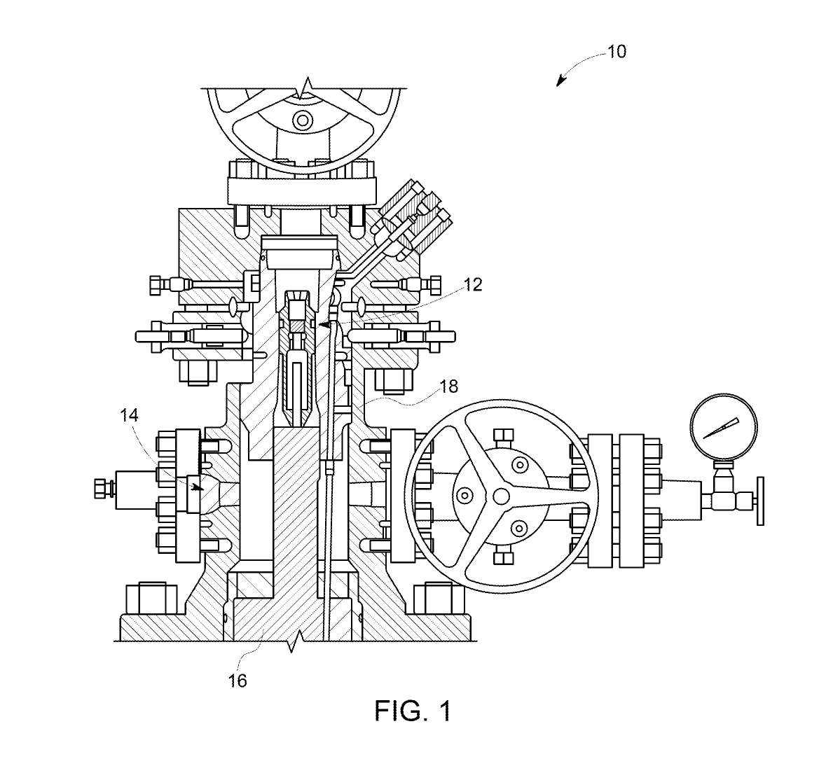

FIG. 1 depicts a cross-sectional view of a high-pressure well-head 10 including one or more back pressure valves 12, which can require replacement on a periodic basis. An access/retrieval plug 14 is disposed upstream of the back-pressure valves 12 for the purpose of cutting off or blocking the pressurized process fluid or medium 16 in the fluid conduit 18. The access/retrieval plug may ensure safe repair/replacement of system components. As used herein, the “wall” of the pipe or conduit means any structure which contains the high pressure fluid, provides a mounting structure for an access/retrieval plug 22 and access to the high pressure fluid in the fluid conduit.

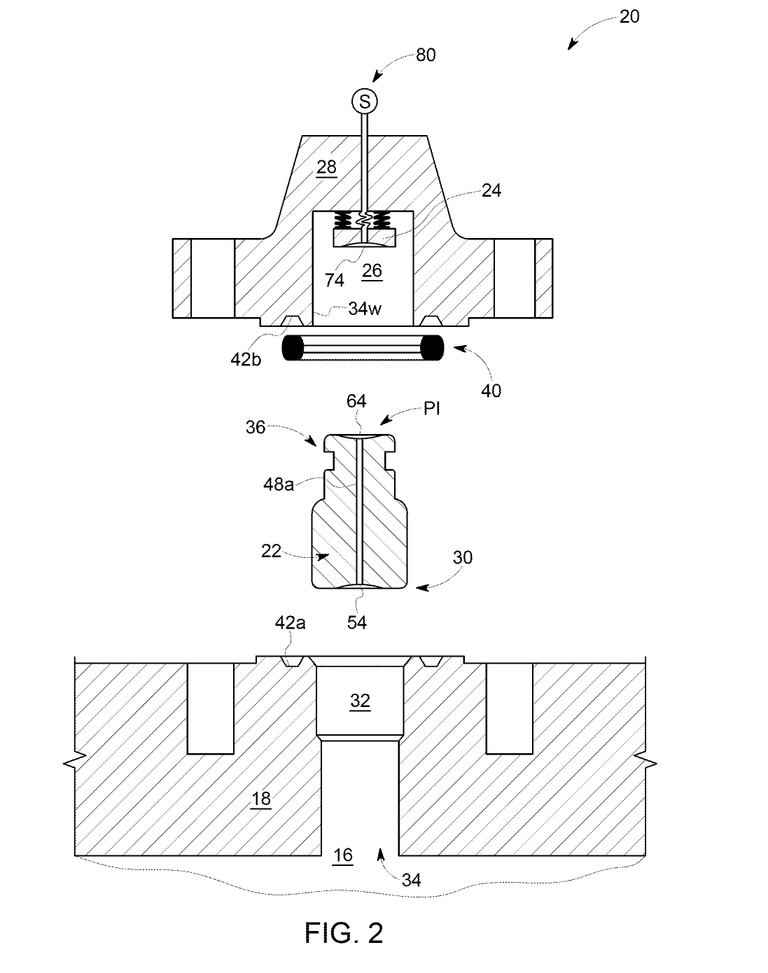

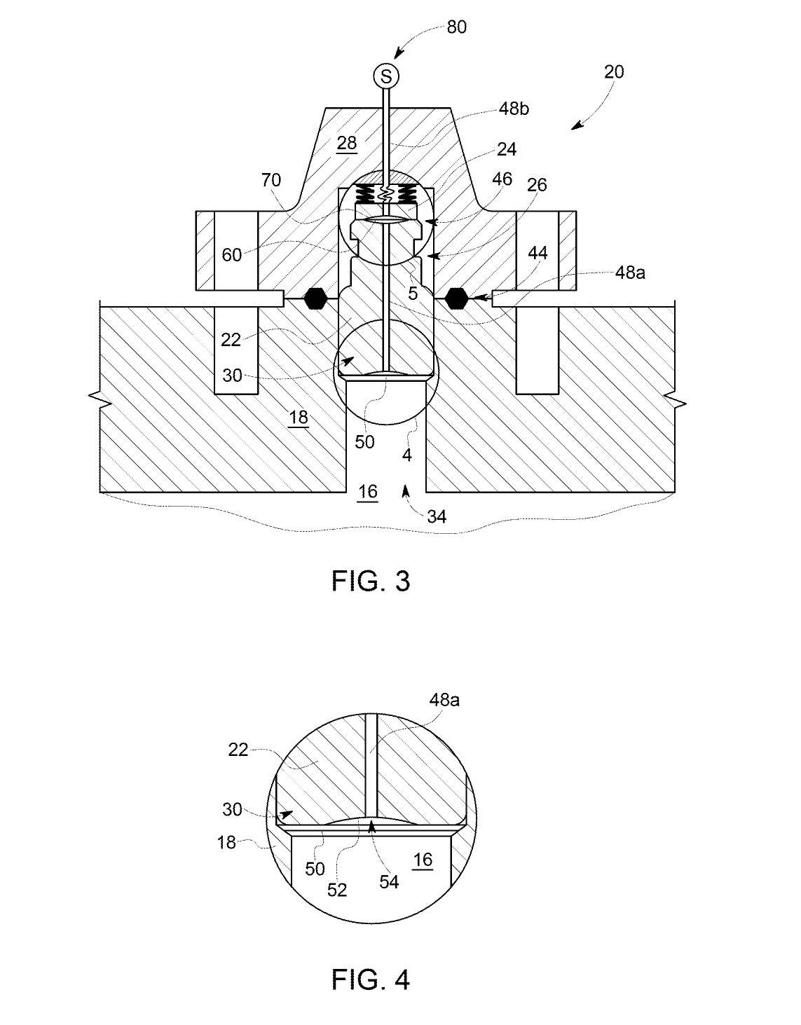

FIGS. 2 and 3 depict exploded and assembled views of a system 20 configured to facilitate removal/replacement of system components in a high pressure fluid environment. More specifically, the system 20 employs a modified access/retrieval plug 22 configured to communicate pressure information of the process fluid 16 through a spring-biased cap 24 which is disposed internally of a cavity 26 of a blind flange or fitting 28. The cavity 26 provides a redundant sealing interface, which may protect an operator from the hazards of repair and maintenance of system components.

In the described embodiment, a first end portion 30 of the access/retrieval plug 22 is disposed within a cavity 32 of the conduit wall 18 which provides access to process fluid 16, and to the internal pressure thereof, through an access port 34. When pressurized, the range of operating pressures will be between atmospheric to about twenty-thousand psi (14.7 to 20000 psi). A second end portion 36 of the access/retrieval plug 22 is received within the cavity 26 of the blind flange or fitting 28. A gasket 40 may be disposed within first and second annular grooves 42a, 42b of the conduit wall 18 and the blind flange 28, respectively, to produce a first sealing interface 44 (see FIG. 3).

While the access/retrieval plug 22 is used principally to facilitate the removal and replacement of valves within the high-pressure fluid environment, the access/retrieval plug 22 can facilitate the access, repair, replacement, retrieval and installation of virtually any component used in such environments. Accordingly, the following description uses the terms “access” “retrieval” and “removal” interchangeably as modifiers for the plug 22. As mentioned in the preceding paragraph, the first end portion 30 is disposed within the first cavity 32 of the conduit wall 18 while the second end portion 36 is disposed within a second cavity 38 of the blind flange fitting 28. In FIG. 2, the access/retrieval plug 22 is configured to transfer an indicated pressure PI from the first end portion 30 to the second end portion 36 of the access/retrieval plug 22 through a transfer/capillary tube 48a. More specifically, and referring to FIGS. 2, 3 and 4, a first metallic diaphragm 50 (illustrated in FIG. 4, for example) can be disposed over a first concave surface 52 formed in an end face of the first end portion 30. As such, the metallic diaphragm 50 defines a first volume or reservoir 54 between the first concave surface 52 and the diaphragm 50.

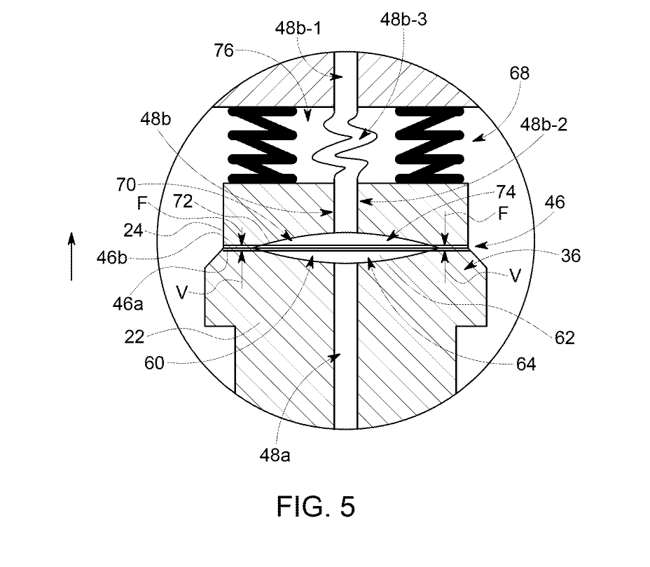

Similarly, and referring to FIGS. 2-5, a second metallic diaphragm 60 is disposed over a second concave surface 62 at the second end portion 36 (best seen in FIG. 5) of the access/retrieval plug 22. The second diaphragm 60 can be generally planar and can define a second volume or reservoir 64 between the second concave surface 62 and the second diaphragm 60. The lower transfer/capillary tube 48a (FIGS. 4 and 5) can connect the first and second defined volumes 54, 64 bounded by each of the first and second diaphragms 50, 60. As such, a pressure sensed/measured in one of the first and second defined volumes 54, 64 can be sensed/measured in the other of the first and second defined volumes 54, 64.

The spring-biased cap 24 can be disposed over the second end portion 36 of the access/retrieval plug 22 and within the second cavity 38 of the blind flange 28. Moreover, the spring-biased cap 24 is configured to: (i) transfer the indicated pressure PI to a remote sensor 80 (see FIG. 2) where the pressure of the operating fluid 16 can be measured, and (ii) produce a redundant seal along a second sealing interface 46 (FIGS. 3 and 5) disposed internally of the blind flange/fitting 28, i.e., within the second cavity 38, for safely containing the high pressure operating fluid 16. Specifically, the spring-biased cap 24 is aligned with, and disposed over, the second end portion 36 of the access/retrieval plug 22 and can be biasingly supported by a coil spring 68.

In the described embodiment, the coil spring 68 (illustrated in FIG. 5) operates independently to urge the cap 24 downwardly against the second end portion 36 of the access/retrieval plug 22, i.e., the second diaphragm 60 thereof. While this arrangement may be sufficient to laterally mount the spring-biased cap 24, a variety of other mounting arrangements may be employed. For example, a telescoping guide (not shown) may be employed to direct the spring-biased cap 24 while translating up and/or down within the guide. Alternatively, the cavity 34 (see FIG. 2) may be machined to guide the side wall surfaces of the spring-biased cap 24.

Similar to the face surfaces of the access/retrieval plug 22, the spring-biased cap 24 may also form a concave surface 72 bounded by a third metal diaphragm 70 which, together, define a third defined volume or reservoir 74. The third diaphragm 70 is laterally aligned, and/or contiguous with, the second diaphragm 60 such that an axial displacement of the second diaphragm 60 can be communicated to the third diaphragm 70. The concave surface 72 is surrounded by a first annular abutment surface 46a disposed radially outward of the concave surface 72. The first annular abutment surface 46a forms a first half of the second sealing interface 46 while a second annular abutment surface 46b, disposed radially outboard of the concave surface 62, forms a second half of the second sealing interface 46. In the described embodiment, the first and second annular abutment surfaces 46a, 46b may form any geometric shape, e.g., planar, converging, diverging, conical, concave and convex surfaces, etc. In the described embodiment, the abutment surfaces 46a, 46b, are orthogonal to a pressure vector V produced by the process fluid 16.

The coil spring 68, therefore, produces a counteracting force vector F which equilibrates the pressure vector V induced by the process fluid 16. While the forces and pressures exerted along the mating interface 46b can be high, i.e., pressure across the second and third diaphragms 60, 70, the coil spring 68 functions to seat the cap 24 against plug 22 such that the pressure within the second diaphragm 60 is contained by the third diaphragm 70. It will be appreciated that the second diaphragm 60 is influenced, sometimes directly, by the pressure induced by the process fluid 16 which is transferred to the second diaphragm 60 via the first diaphragm 50 and lower/first transfer tube 48a. As such, a propensity exists for the second diaphragm 60 to rupture should a counteracting force be removed, such as that provided by the spring-biased cap 24 It is also for this reason that the interface 46b that the interface 46 is fully encapsulated within the protective, bell-shaped, enclosure or cavities 26, 32 of the conduit 18 and blind flange 28, respectively.

In the described embodiment, the upper transfer tube 48b comprises a series of transfer tubes 48b-1, 48b-2, and 48b-3 from the third reservoir 74 to the remote sensor 80. More specifically, a first portion 48b-1 of the upper transfer tube 48b is disposed in the cap 24, a second portion 48b-2 of the tube 48b is disposed in the blind flange 28, and/or a third portion 48b-3 is disposed between the first and second portions 48b-1, 48b-2. The third portion 48b-3 may comprise a compliant tubing, connecting the first and second transfer tubes 48b-1, 48b-2 to accommodate a small degree of axial and/or lateral displacement of the spring-biased cap 24. In the described embodiment, the flexible tubing 48b-3 is disposed internally of the cylindrical volume or central void 76 of the coil spring 68, however, this may simply be a convenient location for the flexible tubing 48b-3.

In the described embodiment, the diaphragms 50, 60, 70 are configured to communicate information regarding the high pressure process fluids from the first diaphragm 50 to the pressure sensor 80. In some instances, in development of the hot swappable pressure sensing system, it was discovered that the system can be most reliable when employing relatively small components and volumes to minimize the pressures acting on the various components. In the described embodiment, the diaphragms 50, 60, 70 each have a diameter dimension which is less than about two inches (2.0″) and, in some instances, less than about one and one half inches (1.50″). Furthermore, the upper and lower transfer/capillary tubes 48a, 48b are less than about one millimeter in diameter. Once again, these dimensions may be standard and are not be deemed limiting when considering the breath of the claimed invention.

The first reservoir 54, transfer tube 48a, and second reservoir 64 may contain an incompressible fluid which is conductive or non-conductive (i.e., a dielectric fluid). While nearly any incompressible fluid may fill the access/retrieval plug 22, in some embodiments, a liquid metal fluid may be best suited to fill the retrieval plug 22. That is, while fluids such as water and oil may be employed, these fluids are, at least to some small degree, compressible under the extremely high pressures of the process fluid 16. Accordingly, metallic fluids which exhibit improved properties, i.e., nearly incompressible even at pressures greater than 5,000 psi, may be best-suited in some instances to fill the transfer tube and reservoirs 48a, 50, 60 of the access/retrieval plug 22. In the described embodiment, liquid metals from the group consisting of: bromine, mercury, cesium, francium, gallium and rubidium may exhibit such favorable properties. It should also be appreciated that the foregoing elements may be mixed with compatible alloys to improve the incompressible properties of the fluid.

While the incompressible fluid which fills the release plug 22 (i.e., the first and second volumes 54, 64 and lower transfer tube 48a) may be a liquid metal, the incompressible fluid filling the spring-biased cap 24 (i.e., the upper transfer tube 48b, and the third volume 74) can comprise a non-conductive, dielectric material. This property may be desirable in some embodiments to prevent a voltage or current from adversely affecting the remote pressure sensor 80. Therefore, the incompressible fluid which is best-suited to fill the upper transfer tube 48b and the third reservoir 74 can be a conventional non-conductive silicone oil. As a consequence, the system 20 may employ two incompressible fluids, i.e., a metallic fluid filling the access/retrieval plug 22 and a non-metallic, non-conductive, dielectric fluid filling the spring-biased cap 24.

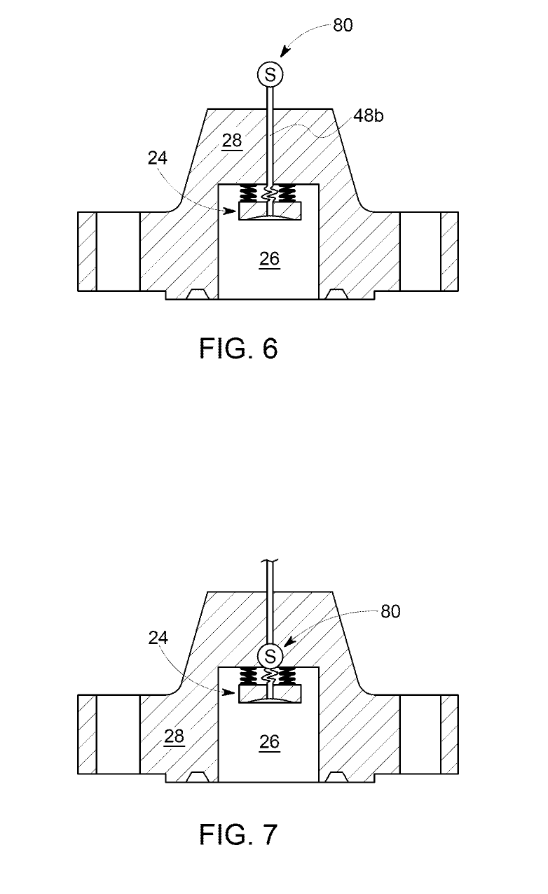

FIG. 6 depicts an alternate embodiment of the disclosure wherein the remote pressure measurement sensor 80 is disposed remotely of the valve release plug and is disposed externally of the blind flange 28. In this embodiment, transfer tube 48b provides the transfer fluid to the measurement sensor 80. Consequently, the upper transfer tube may or may not pass through the coil spring 68.

FIG. 7 depicts yet another embodiment of the disclosure wherein the remote pressure measurement sensor 80 is disposed remotely from the access/retrieval plug 22 yet is disposed internally of the blind flange 28. In this embodiment, an electrical signal indicative of the pressure measurement is carried to a secondary location for reading the signal. While the remote sensor 80 is located within the blind flange 28, the sensor 80 is not embedded within the access plug 22.

In operation, and referring collectively to FIGS. 1-7, the first diaphragm 44, which is disposed over the first end portion 30 of the access/retrieval plug 22, flexes under the pressure applied by the process fluid 18. The lower transfer tube 48a shuttles the incompressible fluid between the first and second diaphragms 50, 60 so as to effect movement of the second diaphragm 60 in response to displacement of the first diaphragm 50. The displacement is proportional to the applied pressure and produces an indicating pressure PI at, or along the surface of, the second diaphragm 60. Inasmuch as the second and third diaphragms 60, 70 are contiguous, the indicating pressure PI is transferred from the second to the third diaphragms 60, 70. Flexure of the third diaphragm 60 displaces the transfer fluid into, and along, the transfer tubes 48b-1, 48b-2 and 48b-3 to the remote pressure measurement sensor 80.

The diaphragms 50, 60, 70, and transfer tubes 48a, 48b provide a fully enclosed system for measuring the high pressure environment of a contemporary oil drilling platform. The remote location of the measurement sensor 80 can facilitate ease of repair/replacement while also allowing access for other purposes. The spring-biased cap 24 produces a sealing interface 46a between the second and third diaphragms 60, 70, or between the spring-biased cap 24 and the second end 36 of the access/retrieval plug 22. The coil spring 68 provides the requisite force, i.e., the product of the process fluid pressure multiplied by the diaphragm area (V×A=F×A, where V is the force vector induced by the process fluid 16, F is the force vector induced by the coil spring 68, and A is the affected area of diaphragm 60 acting on diaphragm 70), to counteract the separation force along the second sealing interface 46b.

The foregoing, therefore, also can also describe a method which facilitates the repair and replacement of consumable components in a high pressure oil distribution system 20. The method comprises the steps of: communicating an indicated pressure PI of a process fluid through a retrieval plug 22 and communicating the indicated pressure 22 to a remote sensor 80. In some embodiments, one of the principle safety advantages can be achieved by producing a primary sealing interface 44 and a redundant sealing interface 46. These steps can include mounting the cap 24 within the blind flange fitting 28 such that a mating interface 46 is produced between the retrieval plug 22 and the mounting cap 24, and encapsulating or placing the mating interface 46 within a protective cavity 36 produced by the blind flange/fitting 28.

To ensure that the system 20 of the present invention is safe in some or all operational modes, a first step in its disassembly is the separation and/or disengagement of the mating interface 46. More specifically, and referring again to FIG. 2, the first metal diaphragm 50 is exposed to the pressure of the process fluid 16 which, in turn, conveys this same, or nearly the same, pressure to the second metal diaphragm 60 through the transfer tube 48a. As such, the thin metal diaphragms 50, 60 are the only structure retaining the pressure of the process fluid 16.

Prior to disengaging the blind flange 28 from the conduit 18, it can be necessary to disengage the mating interface 46 to prevent damage, i.e. rupture of the second mating diaphragm 60, to various system components. To ensure that the plug 22 may be removed without damage, there may be a need to include a means for varying the volume of the incompressible fluid filling the cap 24, i.e., the third reservoir 74 and the transfer tube 48b. This may be achieved by adding fixed quantities of fluid to the reservoir 74 during or immediately prior to disassembly of the blind flange 28 and the access plug 22. The means for introducing or removing fluid from the reservoir 74 is illustrated and described in greater detail in Seeberg et al. U.S. Patent Publication 2014/0373635 entitled “Retrievable Sensor and Method” and is herein incorporated by reference in its entirety.

The access/retrieval plug 22 arrangement, therefore, can reduce: (i) the risk of environmental contamination during replacement of the sensor 80, (ii) hazardous emissions such as exposure to hydrogen sulfide, (iii) the requirement for PPM and/or, (iv) the requirement for expensive tools and equipment, e.g., double block and bleed valves.

To the extent that the claims recite the phrase “at least one of” in reference to a plurality of elements, this is intended to mean at least one or more of the listed elements, and is not limited to at least one of each element. For example, “at least one of an element A, element B, and element C,” is intended to indicate element A alone, or element B alone, or element C alone, or any combination thereof “At least one of element A, element B, and element C” is not intended to be limited to at least one of an element A, at least one of an element B, and at least one of an element C.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
an access plug having a first end portion disposed within a first cavity of a process-fluid conduit, and a second end portion disposed within a second cavity of a blind flange, the first cavity exposed to a pressure environment of a process fluid, the access plug configured to transfer an indicated pressure from the first to the second end portion; and
a cap disposed between the blind flange and the second end portion of the access plug,
wherein the cap is configured to transfer the indicated pressure to a pressure sensor disposed remotely of the access plug.

2. The system of claim 1, wherein the first end portion includes a first diaphragm enclosing a first volume, wherein the second end portion includes a second diaphragm enclosing a second volume, wherein a transfer tube connects the first and second volumes, and an incompressible fluid fills the transfer tube and the first and second volumes such that the indicated pressure may be communicated from the first end portion to the second end portion of the access plug.

3. The system of claim 2, wherein the cap includes a third diaphragm enclosing a third volume, a transfer tube connecting the third volume and the pressure sensor, and an incompressible fluid filling the third volume and the transfer tube such that the indicated pressure may be communicated across the second and third diaphragms of the access plug and cap, respectively, to the remote pressure sensor.

4. The system of claim 2, wherein the incompressible fluid filling the first and second volumes and transfer tube of the access plug is a liquid metal fluid.

5. The system of claim 3, further comprising a means for varying the third volume and wherein the incompressible fluid filling the third volume and transfer tube of the cap is a dielectric fluid.

6. The system of claim 3, wherein the cap is spring-biased against the second end portion of the access plug to counteract a force vector induced by the process fluid.

7. The system of claim 4, wherein the liquid metal fluid is from the group consisting of: bromine, mercury, cesium, francium, gallium and rubidium and alloys thereof.

8. The system of claim 6, wherein the incompressible fluid of the spring-biased cap is silicone oil.

9. The system of claim 6, wherein the cap is spring-biased by a coil spring and wherein the transfer tube connecting the spring-biased cap to the pressure sensor includes a flexible portion.

10. The system of claim 1, wherein the cap and the second end portion of the access plug produces a mating interface, and wherein the mating interface produces a redundant sealing interface surrounded by the internal walls of the blind flange.

11. A method for enabling the repair, and replacement of consumable components in a high pressure oil distribution system, comprising the steps of:
communicating an indicated pressure of a process fluid through an access plug comprising:
first and second fluid reservoirs disposed at a first and a second end, respectively, of the access plug, each of the first and second fluid reservoirs enclosed within a flexible diaphragm; and
a transfer tube connecting the first and second fluid reservoirs such that displacement of one diaphragm effects a displacement of the other diaphragm, the displacement indicative of the indicated pressure of the process fluid; and
communicating the indicated pressure to a remote sensor.

12. The method of claim 11 wherein the step of communicating the indicated pressure includes the steps of:
mounting a cap over the second end of the access plug, the cap comprising:
a third fluid reservoir enclosed within a flexible diaphragm; and
a transfer tube connecting the third fluid reservoir to a remote pressure sensor.

13. The method of claim 12, wherein the step of mounting a cap over the second end of the access plug includes the steps of:
mounting the cap within a blind flange such that a mating interface is produced between the access plug and the cap; and
placing the mating interface within a protective cavity of the blind flange.

14. The method of claim 11, further comprising the step of:
filling the first and second fluid reservoir and transfer tube with a liquid metal from the group consisting of: bromine, mercury, cesium, francium, gallium and rubidium and alloys thereof.

15. The method of claim 12, further comprising the steps of:
varying the volume of fluid of the third fluid reservoir; and
filling the third fluid reservoir and transfer tube of the cap with a dielectric fluid.

16. The method of claim 15, wherein the dielectric fluid of the cap is silicone oil.

17. The method of claim 13, further comprising the step of:
biasing the cap against the second end of the access plug such that an equilibrating force vector is applied to the cap to counteract the force vector induced by the process fluid.

18. An access plug for use in a fluid conduit, comprising:
a first concave surface formed along a first end of the access plug;
a second concave surface formed along a second end of the access plug;
first and second diaphragms disposed over the first and second concave surfaces such that the first diaphragm encloses a first defined volume and the second diaphragm encloses a second defined volume,
a fluid transfer tube connecting the first and second concave surfaces; and
a pressure transfer fluid filling the fluid transfer tube and the first and second defined volumes at each end of the access plug; such that (i) the second diaphragm flexes in response to flexure of the first diaphragm as a consequence of fluid transfer from the first to the second defined volumes and is displaced as a function of an indicated pressure being transferred from the first to the second ends, and transfers the indicated pressure to a sensor disposed remotely of the access plug.

19. The access plug of claim 18, further comprising:
a liquid metal fluid filling the first and second defined volumes of the access plug.

20. The access plug of claim 19, wherein the liquid metal fluid is selected from the group consisting of: bromine, mercury, cesium, francium, gallium and rubidium and alloys thereof.
